(19) United States
(12) Patent Application Publication
(10) Pub. No.: US 2008/0224842 A1
(43) Pub. Date: Sep. 18, 2008

(54) BRAKE WEAR DETECTING METHOD FOR ELECTRIC GOLF CAR AND ELECTRIC GOLF CAR EMPLOYING THE DETECTING METHOD

(75) Inventor: Yukiyasu Takano, Shuzuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA MOTOR ELECTRONICS KABUSHIKI KAISHA, Shizuoka-ken (JP)

(21) Appl. No.: 12/048,081

(22) Filed: Mar. 13, 2008

(30) Foreign Application Priority Data
Mar. 14, 2007 (JP) 2007-064273

(51) Int. Cl. B60Q 1/00

(52) U.S. Cl. 340/454

(57) ABSTRACT

When a user initiates a braking operation, an accelerator position is checked to see if the accelerator opening is about zero, a deceleration threshold value is computed based upon a brake pedal effort, the deceleration of the vehicle is obtained based upon the pedal effort, and an actual deceleration value is obtained by detecting a speed of the vehicle over time. If it is confirmed that an accelerator opening is zero, a comparison is made between the pedal-effort based deceleration threshold value and the actual deceleration are compared to determine if the brake has worn sufficiently to warrant maintenance.

### CROSS-REFERENCE TO RELATED APPLICATIONS

This application claims the priority benefit of Japanese Patent Application No. 2007-064273, which was filed on Mar. 14, 2007 and which is hereby incorporated by reference in its entirety.

### BACKGROUND OF THE INVENTION

1. Field of the Invention

The present invention generally relates to a brake wear detection method for an electric golf car. In addition, certain features, aspects and advantages of the present invention relate to a method for detecting if a brake of an electric golf car has worn to a degree warranting replacement or not as well as an electric golf car to which the detecting method is applied.

2. Description of the Related Art

Conventionally, an electric golf car includes a mechanical brake that is used to slow and stop the car in a manner that generally corresponds with an input pedal effort on a brake pedal. Moreover, the electric golf car can include an electric type brake operated that creates regenerative electric current when an accelerator pedal is released. Japanese Patent Publication No. JP-A-2003-200821 discloses a golf car that includes these two brake mechanisms. The disclosed brake mechanisms are simply constructed and function such that the electric brake is actuated when an abnormality occurs in the mechanical brake.

### SUMMARY OF THE INVENTION

However, the brake mechanisms in JP-A-2003-200821 cannot determine when it is desired to conduct maintenance on mechanical parts of the mechanical brake due to wear caused over time. In other words, a user is not made aware of any impending abnormalities in the brake mechanisms until the abnormality occurs to the brake. Usually a single golf course maintains a large number of golf cars. Different users use the golf cars every day. Therefore, it is difficult for users to evaluate whether the brakes are wearing based upon whether the brakes of the golf cars are working less effectively than a prior experience. If a user is assigned the golf car, of which the brake has been significantly worn, and an abnormality occurs to the mechanical brake while the user is driving the golf car, the user has to cope with the situation. For instance, the user has to stop a golf game and return to the car return to exchange the golf car before resuming the golf game. Thus, the user spends extra time on the golf course and the user is somewhat inconvenienced.

The conventional brake mechanisms are independent from a motor controller unit (MCU) that monitors a state of the golf car by detecting an accelerator position, a vehicle speed, and so forth. Therefore, brake control cannot be related to the information managed in the MCU.

Thus, one aspect of some embodiments of the present invention involves the recognition of these difficulties. Accordingly, a brake wear detecting method is provided for an electric golf car in which effectiveness of the brake is related with other information about vehicle operational states such that wear of the brakes can be detected earlier and a user can be reminded about a desire for maintenance before a braking abnormality occurs.

Another aspect of the present invention involves a brake wear detecting method for an electric golf car. The method comprises: detecting an accelerator opening and evaluating if the accelerator opening is zero or about zero; detecting a load on a brake pedal and obtaining a deceleration threshold value based upon the detected load; detecting a speed of the vehicle and obtaining an actual rate of deceleration. If the accelerator opening is zero or about zero, then a comparison is made between the obtained deceleration threshold value and the obtained actual rate of deceleration and, if the actual deceleration is lower than the deceleration threshold value, then an alert is made of a worn brake being detected.

A further aspect of an embodiment of the present invention relates to an electric golf car comprising an accelerator position detection device adapted to detect the accelerator position, a brake pedal detection device adapted to detect a load on a brake pedal, a vehicle speed detection device adapted to detect a speed of the vehicle and a motor controller unit adapted to compute a deceleration threshold value based upon the detected load from the brake pedal detection device and an actual deceleration based upon output from the vehicle speed detection device. An alarm, the accelerator position detection device, the brake pedal detection device, and the vehicle speed detection device are connected to the motor controller unit such that the alarm can be activated when the accelerator position detection device indicates no operation of the acceleration and when the actual deceleration is less than the deceleration threshold value.

### BRIEF DESCRIPTION OF THE DRAWINGS

These and other features, aspects and advantages of the present invention will now be described with reference to the drawings of a preferred embodiment, which embodiment is intended to illustrate and not to limit the invention, and in which figures:

FIG. 1 is a schematic diagram showing a golf car that is arranged and configured in accordance with certain features, aspects and advantages of the present invention.

FIG. 2 is a flowchart of a brake wear detecting method for the electric golf car of FIG. 1.

### DETAILED DESCRIPTION OF THE PREFERRED EMBODIMENT

Certain features, aspects and advantages of an embodiment of the present invention generally relate to a brake wear detecting method for an electric golf car. In some embodiments of the method, when a user uses the brakes, the position of the accelerator is checked to see if an accelerator opening is zero (e.g., the accelerator pedal is no longer being depressed). In addition, a deceleration threshold value is computed by detecting a pedal effort or load being applied to a brake pedal and by obtaining a deceleration of the vehicle caused by the pedal load. Deceleration then is computed by detecting a speed of the vehicle and obtaining an actual deceleration of the vehicle. Thus, a brake wear detecting method for an electronic golf car is embodied whereby, when the accelerator opening is at or near zero, a comparison can be made between a deceleration threshold value based upon the pedal effort detected and the actual deceleration detected. Thus, brake wear can be predicted when the actual deceleration is lower than the deceleration threshold value and a user can respond to the break wear by seasonably performing desired maintenance. Of course, some aspects of embodiments of the present invention relate to an electric golf car using the aforementioned method.

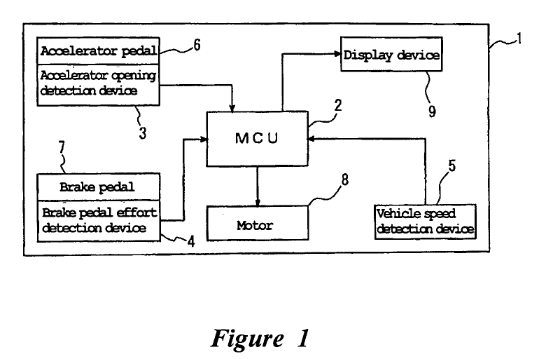

FIG. 1 is a schematic diagram schematically showing a golf car according to the present invention. As shown in the figure, the golf car 1 preferably comprises a motor controller unit (MCU) 2. The MCU 2 is connected to an accelerator opening detection device 3, a brake pedal effort detection device 4, and a vehicle speed detection device 5. The accelerator opening detection device 3 preferably detects an angle to which a user moves or depresses an accelerator pedal 6. The brake pedal effort detection device 4 preferably detects a pedal effort or load of a user that is applied to a brake pedal 7. The vehicle speed detection device 5 preferably detects the revolutions of a rear wheel (not shown) of the golf car 1, for example, and encodes the detected revolutions into suitable pulse signals. Other proxies for one or more of these values also can be detected.

When the golf car 1 is operated, the angle of the accelerator pedal 6 can be input into the MCU 2, and the MCU 2 can drive a motor 8 to cause movement of the vehicle at a speed corresponding to the angle of the accelerator pedal 6 or the amount of movement of the accelerator pedal 6. Thus, the golf car 1 moves through power provided by the motor 8.

When the brake pedal 7 is released, the golf car 1 decelerates. A pulse signal from the vehicle speed detection device 5 is input to the MCU 2. Thus, a vehicle speed can be computed in the MCU 2. In some configurations, the vehicle speed can be input into the MCU 2. The actual deceleration can be calculated based upon a difference between a traveling speed before the brake pedal 7 is pressed and a traveling speed at a certain period after the brake pedal has been pressed.

When the brake pedal 7 is pressed, the brake pedal effort detection device 4 detects the load on the pedal, for instance, and the pedal effort is input to the MCU. The MCU 2 calculates a deceleration threshold value of the vehicle 1 (e.g., the golf car) at the detected pedal effort. In other words, the MCU 2 can estimate a deceleration that normally can be expected when the brake pedal 7 receives the force sensed by the device 4. The deceleration threshold value preferably is a value lower than the appropriate deceleration of the golf car 1 corresponding to the pedal effort on the brake pedal 7 and a value higher than the deceleration experience when the brakes have worn to a degree such that brake maintenance would be desired.

The appropriate deceleration corresponds to deceleration of the vehicle 1 when the brake is operating in a condition such that the brake in not yet worn and there is no malfunctioning within the brake system. The deceleration such that maintenance is desired is a value such that traveling of the vehicle cannot be controlled to a desired level although the brake is operated. The threshold value is a value higher than such a deceleration, at which the brake has been worn such that the brake wear starts to affect a desired level of control of the golf car 1. Since the brake can be worn such that a range of deceleration results, a service technician can define at what level of brake wear the service technician typically provides maintenance and set a deceleration threshold value in the desired range.

The deceleration threshold value may change depending on a slope of a road, for instance. Therefore, the deceleration threshold value may be obtained or varied in consideration of the slope by using an incline sensor, and the like.

The MCU 2 compares the calculated or detected actual deceleration with the deceleration threshold value. The MCU 2 can determine that the brake is less effective, that is, the brake performance is decreased, if the actual deceleration is lower than the deceleration threshold value, and thus determines that the brake has worn to a set level. The determination is made while confirming that the accelerator pedal 6 is not being used, that is, the accelerator opening is at or about zero.

The MCU 2 displays that the brake is worn on a display device 9 if it determines that the brake has sufficiently worn. An LED lamp is used for the display device 9, for example. Other types of alarms, including audible and tactile, can be used.

Accordingly, effectiveness of the brake can be related with other information about the vehicle (e.g., the actual deceleration and the status of the accelerator movement), and thereby the brake wear can be detected before the brake becomes so worn as to lead one to perform maintenance of the brakes. Further, the display device 9 displays the state, and reminds a golf car service technician of desired maintenance.

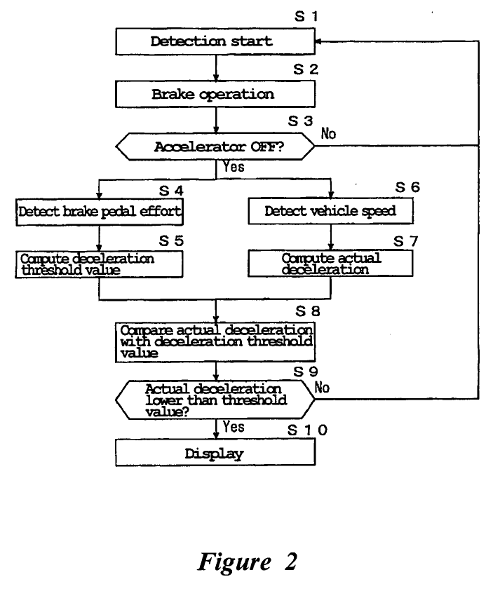

With reference now to FIG. 2, a brake wear detecting method that is arranged and configured in accordance with certain features, aspects and advantages of an embodiment of the present invention will be explained in further detail.

### Step S1:

When the golf car is operating, the MCU starts evaluating the brake wear. To evaluate brake wear, the MCU receives information relating to the accelerator position, the brake pedal load, and the vehicle speed.

### Step S2:

A user operates the brake while driving the golf car. The brake operation preferably is made by depressing the brake pedal. The brake operation is not limited to depressing the brake pedal, but may be made with any other action that actuates a brake mechanism included in the golf car. Therefore, the “brake pedal effort”, which is described later, is not limited to the depressing force, but represents an operation amount used during brake operation.

### Step S3:

If the brake is operated in step S2, the accelerator opening detection device determines if the accelerator is OFF or not (e.g., the accelerator opening checking step). If the accelerator is ON, because an accurate actual deceleration, which will be mentioned below, cannot be calculated, the step returns to step S1.

### Step S4:

If the accelerator is not being depressed, then the brake pedal effort is sensed.

### Step S5:

Once the brake pedal effort has been sensed, a deceleration threshold value is obtained by computation based, at least in part, on the brake pedal effort input in step S4 (e.g., the deceleration threshold value computing step). As described above, the deceleration threshold value is a value lower than the appropriate deceleration of the golf car corresponding to the pedal effort on the brake pedal and a value higher than the deceleration that is experienced when brake maintenance is desired. That is, the deceleration threshold value is a value slightly larger than a value such that the travel controlling operation starts being affected due to brake wear.

### Step S6:

The vehicle speed detection device detects a speed of the vehicle. In some embodiments, the vehicle speed detection device detects the speed of the vehicle simultaneously with step S4.

### Step S7:

The actual deceleration of the vehicle preferably is obtained by a computation from the speed of the vehicle input in step S6 (e.g., the deceleration computing step for an actual deceleration). The actual deceleration is a value indicating how much a speed of the vehicle decreases after a lapse of a certain period. Other techniques also can be used to determine the actual deceleration.

### Step S8:

A comparison is made between the deceleration threshold value obtained in step S5 and the actual deceleration obtained in step S7.

### Step S9:

A determination is made whether the actual deceleration is lower than the deceleration threshold value or not. If the actual deceleration is higher, it means that the brake performance is not decreased sufficiently to desire servicing. Thus, the step returns to step S1.

### Step S10:

If the actual deceleration is lower than the deceleration threshold value, the display device alerts the user to the situation. If the actual deceleration is lower than the deceleration threshold value, it is a point at which the travel controlling operation of the brakes starts to be affected. Therefore, brake maintenance may be desired. Such a situation can be displayed by an LED lamp and the like. Thus, a service technician for the golf car can be reminded about desirability of maintenance. The deceleration lowers not only if the brakes are worn but also if a component is malfunctioning in the brake system. Therefore, the detecting method also can be used for detection of brake wear as well.

In the brake wear detecting method described above, a determination about brake wear is made using the deceleration threshold value and the actual deceleration because it is difficult for service technicians, who maintain large numbers of golf cars, to readily determine the brake wear of each vehicle. A wear determination does not have to be made during every brake operation, but it is sufficient to perform a brake wear determination one or a few times per day. In some embodiments, a determination may be conducted only on a flat road. Thus, a system such as an incline sensor that would be used to take into account sloping ground is not necessary. Thus, the construction can be simplified.

In the view of the ability to evaluate brake wear, the deceleration threshold value is not set based upon a non-worn brake but, instead, is set to a level that allows some wear while not allowing the brake to be so worn that operation is significantly impacted by the brake wear. Since brakes wear with use, the threshold value is set to such a value, thereby service technicians for the golf cars can know the appropriate timing for desired brake maintenance, and the service technicians can give more timely maintenance.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A brake wear detecting method for an electric golf car, the method comprising:
detecting an accelerator opening and evaluating if the accelerator opening is zero or about zero;
detecting a load on a brake pedal and obtaining a deceleration threshold value based upon the detected load;
detecting a speed of the vehicle and obtaining an actual rate of deceleration;
if the accelerator opening is zero or about zero, then a comparison is made between the obtained deceleration threshold value and the obtained actual rate of deceleration and, if the actual deceleration is lower than the deceleration threshold value, then an alert is made of a worn brake being detected.

2. The method according to claim 1, wherein the deceleration threshold value is a value lower than a value indicative of an appropriate deceleration of the vehicle corresponding to the detected load on the brake pedal and the deceleration threshold value is a value higher than deceleration occurring when a brake has worn to a degree such that brake maintenance is desired, and wherein the appropriate deceleration is deceleration of the vehicle at the time of brake operation when the brake has no wear or malfunction.

3. The method of claim 2, wherein the brake causes no deceleration when the brake has worn to the degree such that brake maintenance is desired.

4. An electric golf car comprising:
an accelerator position detection device adapted to detect the accelerator position;
a brake pedal detection device adapted to detect a load on a brake pedal;
a vehicle speed detection device adapted to detect a speed of the vehicle; and
a motor controller unit adapted to compute a deceleration threshold value based upon the detected load from the brake pedal detection device and an actual deceleration based upon output from the vehicle speed detection device;
wherein an alarm, the accelerator position detection device, the brake pedal detection device, and the vehicle speed detection device are connected to the motor controller unit such that the alarm can be activated when the accelerator position detection device indicates no operation of the acceleration and when the actual deceleration is less than the deceleration threshold value.
